(19) United States
(12) Patent Application Publication
(10) Pub. No.: US 2005/0184111 A1
(43) Pub. Date: Aug. 25, 2005

(54) Combination latch and support structure for a vehicle spare wheel carrier

(76) Inventors: Anthony J. Newbill, Wickenburg, AZ (US); James W. Newbill, Wickenburg, AZ (US)

Correspondence Address: James D. Givnan, Jr., 8175 S. W. Ernst Road, Portland, OR, 97225, US

(21) Appl. No.: 10/784,654

(22) Filed: Feb. 23, 2004

(51) Int. Cl. B62D 43/00

(52) U.S. Cl. 224/42.21

(57) ABSTRACT

A vehicle spare wheel is carried by an arm swingable about a vertical axis away from the rear of the vehicle. A powered extensible control subsequently positions the arm about a horizontal axis during wheel removal. A base is mounted on the vehicle rear bumper and supports the arm and control therefor. A latch assembly on the arm and base includes a housing that receives a ball member when the spare wheel is stowed on the vehicle. A lock biases the ball member into housing engagement.

### BACKGROUND OF THE INVENTION

The present invention pertains generally to structure for stowing a vehicle spare wheel adjacent the rear bumper of a vehicle.

With the introduction of sport utility vehicles, which typically are equipped with wheels of a size and weight greater than those of a typical passenger vehicle, the problems of carrying a spare wheel and utilizing same have arisen. As the greater than normal size of the spare wheel discourages storage within the interior of a sports utility vehicle the spare wheel is frequently stored for transport externally adjacent the vehicle back bumper. An issued U.S. patent, later incorporated by reference, addresses the problem of spare wheel storage and the lifting and lowering of such a spare wheel having a weight exceeding 100 pounds in certain large sport utility vehicles. A portion of the present invention is directed toward supporting an externally carried spare wheel for a sports utility vehicle and subjected to severe dynamic loads. Dynamic loads imparted to a spare wheel and the support structure therefor subjects the spare wheel carrier to extreme loading. An associated problem with the securing or latching of a spare wheel carrier in place is the susceptibility of the carrier to exaggerate any clearances in a carrier latch resulting in a rattling of the carrier especially when the vehicle traverses irregular ground surfaces.

In the prior art, U.S. Pat. No. 5,186,371 discloses a body mounted spare wheel carrier having a frame which swings about a vertical axis and carries a mechanism for manual lifting and lowering a spare wheel. The supporting frame engages a latch receptacle 24 fixedly mounted on the vehicle tailgate.

By way of background, U.S. Pat. No. D473,835 discloses a spare wheel carrier having a horizontal arm which carries the spare wheel for travel about a vertical axis provided by a bracket bolted in place on a frame extension of a sport utility vehicle. A distal end of the arm engages a second support associated with a second extension on a vehicle frame to provide adequate support of the spare wheel assembly carrying arm.

Also in the background, U.S. patent application Publication 2003/0024958 discloses a spare wheel carrier intended for use on a military version of a sports utility vehicle and termed a Hum Vee. A counterpart vehicle for civilian use is termed a Hummer. A horizontal arm swings about a vertical pivot and carries a winch for lifting and lowering a spare wheel assembly on a second or pivoted arm carried by the horizontal arm. A latch for the carrier includes a pin dropped through openings in an arm extension and a bumper mounted bracket.

### SUMMARY OF THE PRESENT INVENTION

The present invention is directed toward the provision of a support structure including a latch securing an arm of a spare wheel assembly carrier against severe loads randomly applied to the carrier and spare wheel during vehicle travel. An elongate base is carried by rearwardly extending extensions from the vehicle frame. The base carries a latch component engaged by an arm mounted housing which swings about a vertical axis during loading and unloading of the spare wheel.

### BRIEF DESCRIPTION OF THE DRAWINGS

In the accompanying drawings:

FIG. 1 is an elevational view of the present invention in place on the rear of a vehicle;

FIG. 2 is an enlarged fragmentary view of a latch assembly shown in FIG. 1;

FIG. 3 is a bottom plan view of FIG. 2; and

FIG. 4 is a fragmentary elevational view of the base of a spare wheel carrier with attaching bolts removed.

### DETAILED DESCRIPTION OF THE DRAWINGS

With continuing attention to the drawings wherein applied reference numerals indicate parts similarly hereinafter identified, the reference numeral I indicates generally a vehicle bumper suitably secured to the frame of the vehicle. Extending rearwardly from the frames of vehicles such as a Hum Vee or its civilian counterpart the Hummer, are supports 2 (FIG. 4) for D rings 3. D rings 3 are confined in place by clamps 4 secured by bolts 5.

A support structure is indicated generally at 10 and includes an elongate base 11 secured in place in abutment with bumper 1 by the passage of bolts 5 in seated engagement with rearwardly extending supports 2 carried by the vehicle frame. Base 11 has a flange at 12. Weldments at 13 reinforce flanges 12. A tubular center section is at 15. A fragment of base 11 is shown in FIG. 4 and defines bolt receiving openings at 14 for securement of the support structure to the rearwardly directed supports 2 of the vehicle.

A spare wheel assembly is indicated generally at 20 including a tire and wheel or hub 21. An arm 23 of a spare wheel carrier, generally at 22, is positionable about multiple axes i.e., a vertical axis 24 and powered about a horizontal axis 25 by a motorized linear actuator at 26. U. S. Patent 6,659,318, issued to the present inventor, is incorporated herein by reference and discloses details of spare wheel carrier 22 as well as a modified spare wheel carrier having a manually operated arm 23 for depositing the wheel assembly on a ground surface and subsequent lifting of the spare wheel assembly for spare wheel storage. A bracket 27 includes a pair of plates which serve to carry wheel supporting arm 23 and also an end of actuator 26. A post 28 on base 1 receives a bearing sleeve 29 which carries bracket plates 27 enabling manual rotation of arm 23 about vertical axis 24.

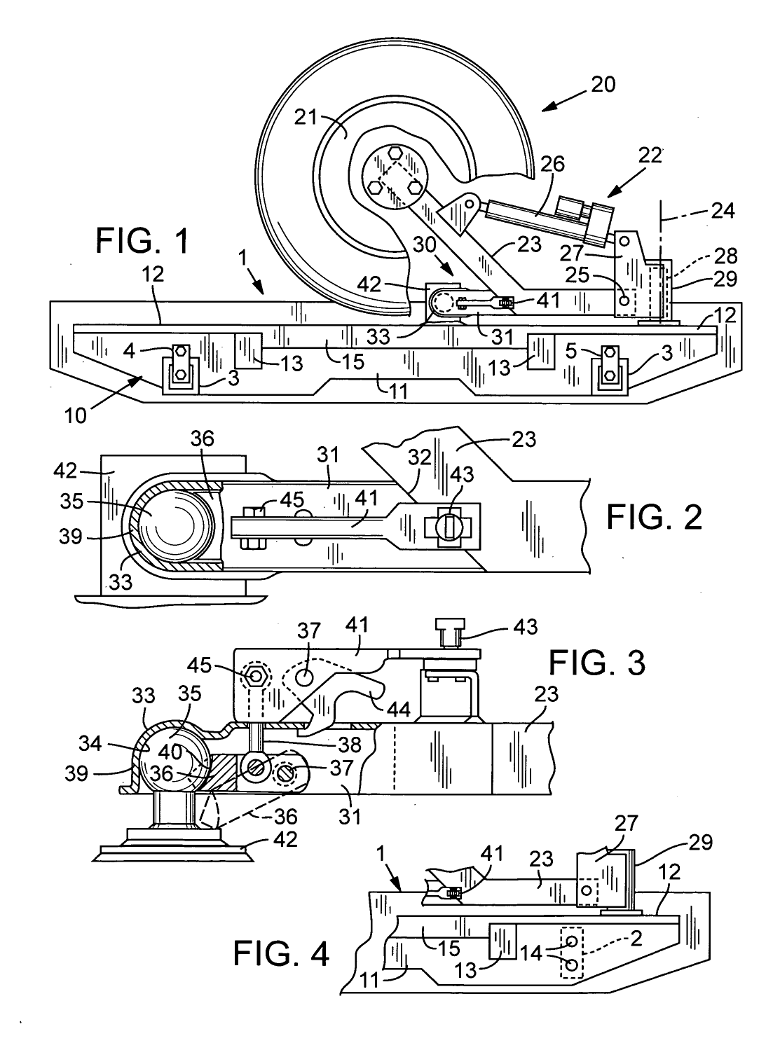

A latch or assembly is indicated generally at 30 and serves to retain arm 23 in position somewhat rearward and transversely of the vehicle body during vehicle travel. Latch or coupler 30 includes a housing 31 of elongate shape terminating in securement at one end 32 to arm 23 as by welding. The elongate housing terminates oppositely and in a partially hemispherical end 33 with a concave inner surface 34 for abutment with a ball component 35. Ball 35 is affixed to a support mounted plate 42. With attention to FIG. 3, it will be noted that the outer end of housing 31 moves into engagement with ball member 35 with the former seating without axial displacement of housing 31 as best viewed in FIG. 3. A curved wall segment 39 of housing end 33 is formed about a single axis permitting ball and housing engagement without axial displacement. A lock at 36 moves about a pin 37 extending through the housing in response to movement of a rod 38 displaced upon rotational lifting and lowering a handle 41 about pivot pin 45. Lock 36 has a spherical wall surface 40 which abuts ball member 35 when lock 36 is in the raised, operative position shown to prevent horizontal movement of housing 31 away from the ball member. Upon release of a safety latch at 44 and subsequent raising of handle 41, rod 38 shifts to displace lock 36 to the broken line position in FIG. 3 permitting separation of housing 31 from the ball member. The abutment of the curved interior 34 of housing end 32 prevents vertical displacement of housing 31 and arm 23, as viewed in FIG. 1, during vehicle travel in response to vertical loads imparted to arm 23 by the weight of the spare tire assembly. Additionally, fore and aft directed loads on arm 23, incurred during vehicle travel, are countered by lock 36 and the partially hemispherical end 33 of the housing. Latch 30 includes features in common with an automotive trailer hitch.

A key operated lock at 43 rotates through 90 degrees to lock-unlock handle 41.

While we have shown but one embodiment of the invention, it will be apparent to those skilled in the art that the invention may be embodied still otherwise without departing from the spirit and scope of the claimed invention.

1. A combination latch assembly and support structure for a vehicle spare wheel carrier having an arm movable about a vertical axis, said latch assembly and support structure comprising,
an elongate base,
attachment means for securing the elongate base to the vehicle transversely of the vehicle center line, and
said latch assembly carried by the arm and said base and including a ball member and a housing having a partially hemispherically shaped end for reception of the ball member when the arm is in a stowed position parallel to said base during vehicle travel and a lock for retention of the ball member in said housing.

2. In a vehicle spare wheel carrier having an arm supporting a spare wheel for travel about an axis during removal and installation of the spare wheel on the carrier, the improvement comprising,
a base for attachment to the vehicle,
a ball member on said base,
a latch assembly including a housing having a partially hemispherically shaped end for reception of the ball member and a lock for retention of the ball member in said housing securing the arm supporting the spare wheel against movement about said axis.

3. The improvement claimed in claim 2 wherein said end of the housing has a curved wall segment formed about a single axis.

4. The improvement claimed in claim 2 additionally including a lock moveable mounted in said housing, a handle coupled to said lock for displacement of the lock into abutment with the ball member to secure the arm to said base.

5. The improvement claimed in claim 4 additionally including a safety latch on said handle and engageable with the housing to prevent handle movement relative the housing.

6. In a spare wheel carrier on a vehicle and having an arm positionable about a vertical axis, the improvement comprising,
an elongate base,
attachment means for securing the base to the vehicle,
a latch assembly for retention of the arm including a ball member, a housing engageable with the ball member and having a partially hemispherical end for abutment with the ball member and a lock confining the ball member in such abutment.

7. The improvement claimed in claim 6 wherein said partially hemispherical end of the housing merges with a curved wall segment of the housing, said ball member and said curved wall segment formed on like radii permitting seating of the ball member in said curved wall segment of the housing without momentary displacement of the housing.
